(19) United States
(12) Patent Application Publication
(10) Pub. No.: US 2004/0265083 A1
(43) Pub. Date: Dec. 30, 2004

(54) Methods and systems for securing wheeled vehicles

(76) Inventor: Shane A. Johnson, Lehi, UT (US)

Correspondence Address: Julie H. Gheem, KIRTON & McCONKIE, Suite1800, 60 East South Temple, Salt Lake City, UT, 84111, US

(21) Appl. No.: 10/873,534

(22) Filed: Jun. 22, 2004

Related U.S. Application Data
(60) Provisional application No. 60/482,088, filed on Jun. 24, 2003.

(51) Int. Cl. B60P 3/06

(52) U.S. Cl. 410/30

(57) ABSTRACT

Methods and systems whereby a wheeled vehicle becomes secured on a trailer bed when the wheeled vehicle rolls over one or more wheel positioners coupled to the surface of the trailer bed. The wheel positioner comprises a ramp and a seat.

### RELATED APPLICATION

This application claims priority to the U.S. Provisional Patent Application Ser. No. 60/482,088, filed Jun. 24, 2003, and titled METHODS AND SYSTEMS FOR SECURING WHEELED VEHICLES.

### BACKGROUND

1. Field of the Invention

The present invention relates generally to methods and systems for securing wheeled vehicles to a transporting surface. More particularly, the present invention relates to methods and systems whereby a wheeled vehicle becomes secured on a trailer bed when the wheeled vehicle rolls over an attachment coupled to the surface of the trailer bed.

2. Background Information

Wheeled vehicles are often transported by being placed on a trailer bed that is attached to a truck or other automobile. For example, outdoor enthusiasts frequently transport their recreational wheeled vehicles on a trailer bed. Such recreational vehicles may include all-terrain vehicles (“ATVs”), motorcycles, snowmobiles, and the like. People who desire to transport their recreational vehicles are often hindered, however, because the process of transporting these wheeled vehicles is cumbersome. Not only does it typically take several steps to secure the wheeled vehicles to the trailer bed, but many securing methods also fail to prevent the wheeled vehicles from rolling while being transported on the trailer bed.

A system for securing wheeled vehicles to trailer beds that is simply constructed, simple to operate, and quick to employ would therefore be an extremely valuable invention. Not only would this be valuable to outdoor enthusiasts who desire to transport recreational vehicles; this would also be valuable in the multitude of situations in which wheeled vehicles are transported upon trailer beds.

### SUMMARY AND OBJECTS OF THE INVENTION

The present invention can generally be characterized as a system whereby a wheeled vehicle becomes secured onto a trailer bed when the wheeled vehicle rolls over one or more wheel positioners coupled to the surface of the trailer bed. The wheel positioner basically comprises a ramp and a seat, the ramp preferably being biased by a biasing device.

Accordingly, it is an object of some embodiments of the present invention to provide methods and systems for securing a wheeled vehicle to a transporting surface by rolling the vehicle over a pivotable ramp and into a cradle.

It is another object of some embodiments of the present invention to provide methods and systems for securing an ATV to a trailer bed via a ramp-cradle device that is fixed to the surface of the trailer bed.

It is a further object of some embodiments of the present invention to provide a simple and convenient way to position and secure a wheeled vehicle to a transporting surface.

It is yet another object of some embodiments of the present invention to provide methods and systems for securing a wheeled vehicle to a transporting surface by rolling the vehicle onto a biased ramp that flips up as it is being rolled over and flips back to its original position after the vehicle has finished rolling over it.

### BRIEF DESCRIPTION OF THE DRAWINGS

Various objects and features of the present invention will become more fully apparent from the accompanying drawings when considered in conjunction with the following description and appended claims. Although the drawings depict only typical embodiments of the invention and are thus not to be deemed as limiting the scope of the invention, the accompanying drawings help explain the invention in added detail.

FIG. 1 is a perspective view showing an ATV about to be secured by wheel positioners in accordance with one embodiment of the present invention.

FIG. 2 is a perspective view of one embodiment of the present invention wherein an ATV is being secured by wheel positioners.

FIG. 3A is an enlarged perspective view of one embodiment of the wheel positioners of the present invention; FIG. 3B is a similar view of another embodiment of the present invention.

FIG. 4 is a perspective of wheel positioners coupled to a coupling device in accordance with one embodiment of the present invention.

FIG. 5 is an enlarged perspective view of an adjustable bar in accordance with one embodiment of the present invention.

### DETAILED DESCRIPTION OF THE PREFERRED EMBODIMENTS

The following detailed description, in conjunction with the claims and accompanying drawings (hereby expressly incorporated as part of this detailed description), sets forth specific numbers, materials, and configurations in order to provide a thorough understanding of the present invention. A purpose of this detailed description being to describe the invention so as to enable one skilled in the art to make and use the present invention, the following description sets forth various specific examples, also referred to as “embodiments,” of the present invention. While the invention is described in conjunction with specific embodiments, it will be understood, because the embodiments are set forth for explanatory purposes only, that this description is not intended to limit the invention to these particular embodiments. Indeed, it is emphasized that the present invention can be embodied or performed in a variety of ways. The detailed description is merely representative of particular embodiments of the present invention.

Reference will now be made in detail to several embodiments of the invention. The various embodiments will be described in conjunction with the accompanying drawings wherein like elements are designated by like numeric or alphanumeric characters throughout.

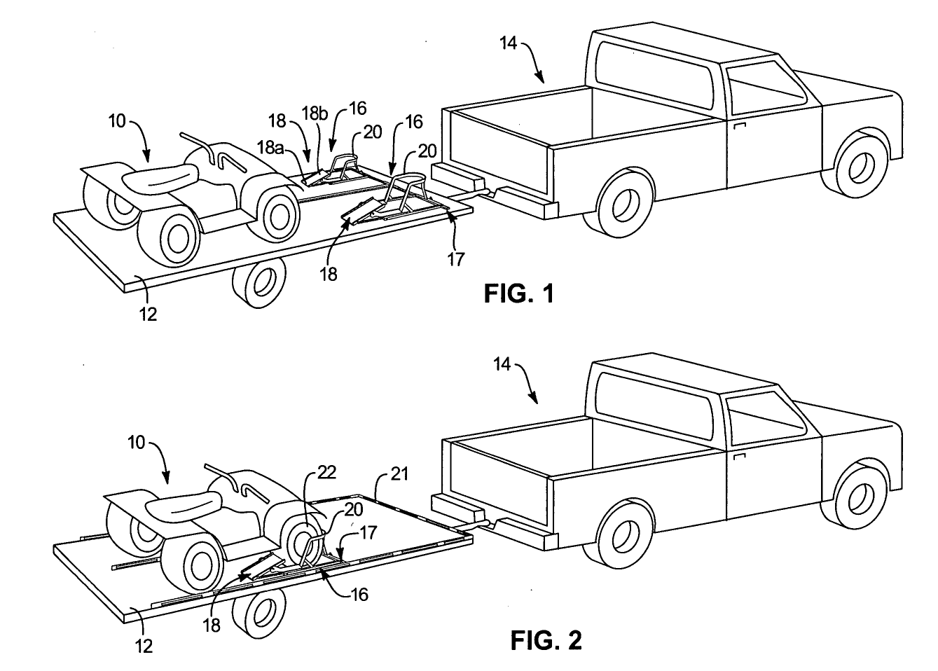

Shown in FIG. 1 is an ATV or other wheeled vehicle 10, a trailer bed 12 for transporting the wheeled vehicle 10, an automobile or truck 14 for pulling the trailer bed 12, and one or more wheel positioners 16 that are designed to be coupled to the surface of the trailer bed 12 via a coupling device 17. The wheel positioners 16 each basically comprise a ramp 18 and a cradle or seat 20.

The wheeled vehicle 10 may comprise any type of wheeled vehicle that can be transported on a moving surface. As previously mentioned, the wheeled vehicle 10 may comprise an ATV. Other examples of wheeled vehicles 10 include motorcycles, snowmobiles, and recreational vehicles having any number of wheels. Some embodiments of the present invention may be configured to work with wheeled vehicles 10 comprising heavy machinery such as backhoes, forklifts, tractors, etc.

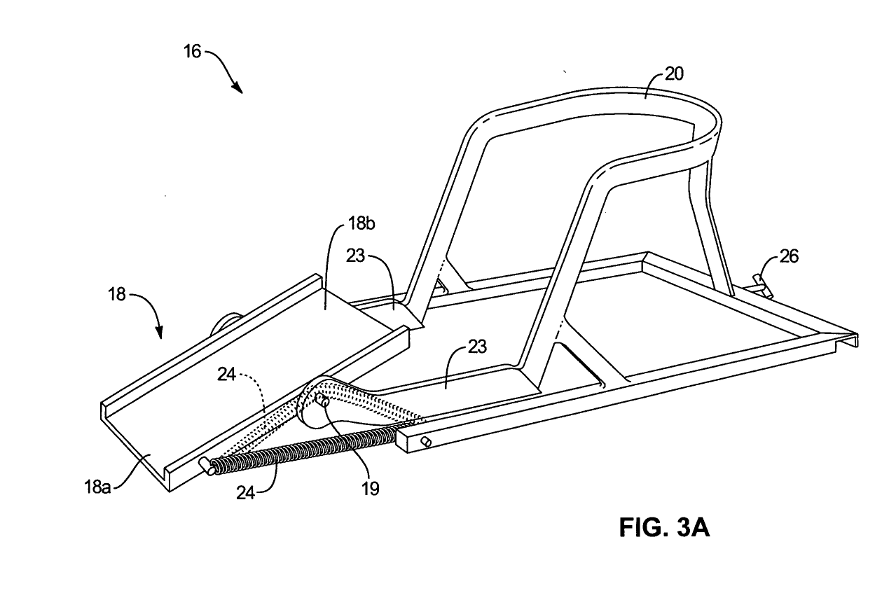

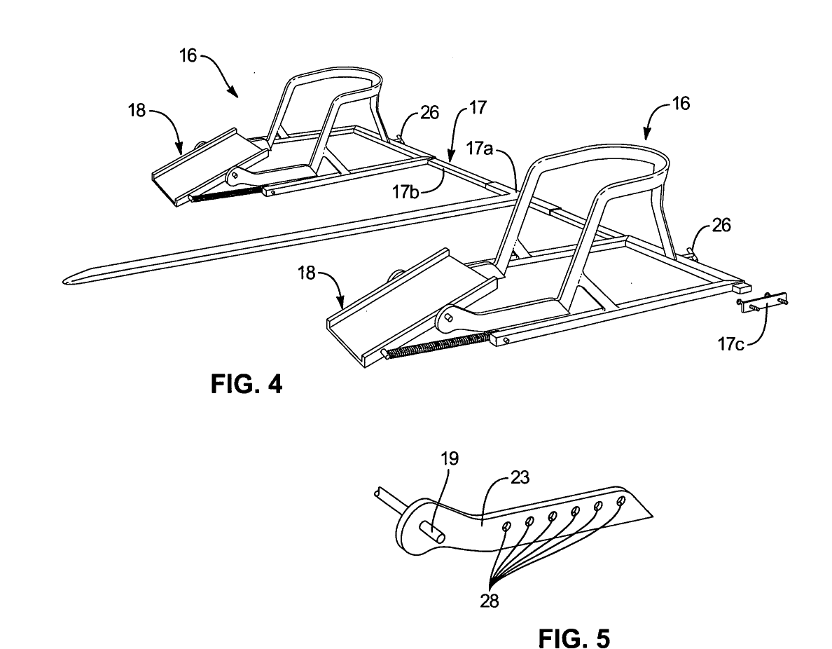

The trailer bed 12 comprises a surface upon which the wheeled vehicle 10 rests while being transported. Trailer bed 12 may have any type of surface, whether it be smooth, ridged, curvy, or have a combination of any of these characteristics. For example, the trailer bed 12 may be a typical flatbed trailer. In some embodiments of the present invention, the trailer bed 12 may also have sides 21 (see FIG. 2) perpendicular to the trailer bed surface, the sides 21 surrounding or partially surrounding the transporting surface of the trailer bed 12. In one embodiment of the present invention, sides 21 are made of metal or other suitable sturdy materials so that coupling device 17 can be bolted thereon, as described further in conjunction with FIG. 4.

FIG. 1 depicts the wheeled vehicle 10 in the process of being moved into position on the trailer bed 12. At this stage, as can be seen in the drawing, the ramps 18 on the wheel positioners 16 are in a position that allows wheels 22 on one side of the wheeled vehicle 10 to access and roll up the ramps 18. In particular, each ramp 18 has a first end 18a and a second end 18b, the first end 18a at this stage being pointed downwards towards the surface of the trailer bed 12 in accordance with one embodiment of the present invention.

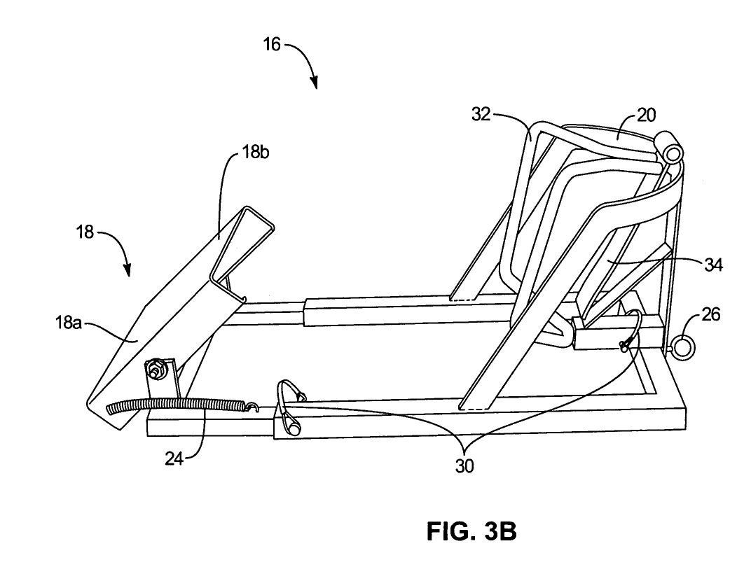

FIG. 2 shows the wheeled vehicle 10 in a position on the trailer bed 12 such that the wheeled vehicle 10 is ready for transport. In order to reach this position, the wheels 22 on the wheeled vehicle 10 are caused to roll over the ramps 18—whether this is accomplished by pushing or pulling the vehicle 10, by driving the wheeled vehicle 10 forward onto the ramps 18, or by some other means. In the preferred embodiments of the present invention, the ramps 18 are pivotably biased so that when the wheels 22 roll over the ramps 18, the weight of the wheels 22 cause each ramp to flip up or pivot around an axis 19 (see FIG. 3A) so that the first end of the ramp 18a travels upwards, and the second end of the ramp 18b travels downwards towards the surface of the trailer bed 12 (the biasing device will be discussed hereafter). As soon as the wheels 22 of the wheeled vehicle 10 have rolled over the ramps 18, the wheels 22 fall into the cradles or seats 20 of the wheel positioners 16, and, with respect to the ramps 18 of the preferred embodiments, the ramps 18 flip back to their original positions so that the wheels 22 cannot roll backwards down the ramps 18. A conventional tie-down (not shown) may be used to further secure the wheeled vehicle 10.

After the wheeled vehicle 10 has been transported by the automobile 14 to the place desired, a person can release each of the ramps 18 from the position shown in FIG. 2 by releasing a biasing device or spring 24 on each of the ramps 18. Biasing device 24 is what causes the ramps 18 to flip or rotate back to their original positions after the wheels 22 have rolled over them and into their respective seats 20. As can been seen in FIG. 3A, one embodiment of the biasing device 24 comprises a spring that may be placed by hand over the axis 19 (into the position shown in stippled lines) in order to allow a person to flip the ramps 18 up so that end 18b points downwards towards the trailer bed 12, thereby allowing the wheeled vehicle 10 to be driven or otherwise moved backwards over the ramps 18 and off of the trailer bed 12. In some embodiments, the biasing device 24 can be activated by a simple lock pin (not shown) placed, for example, at axis 19. However, any sort of appropriate biasing device 24 may be used in the present invention.

FIG. 3B illustrates another embodiment of the present invention wherein the seat 20 further includes parts that are specially designed to grip a motorcycle wheel. For example, v-shaped cradle 32, combined with wheel rest 34 are shaped to grip a motorcycle wheel so as to help prevent the motorcycle from wobbling while being transported. One advantage of these motorcycle grips is the ability to accommodate various sizes of wheels. Another advantage is that the wheel needn't be positioned exactly in the seat 20 because the v-shaped cradle 32 automatically guides the wheel.

FIG. 4 shows a coupling device 17 for coupling the wheel positioners 16 to the trailer bed 12. In this embodiment, the coupling device 17 comprises a first bar 17a and a second bar 17b wherein the second bar 17b is adjustable so as to be able to accommodate different widths of wheeled vehicles 10. The coupling device 17 may be bolted to sides 21 of the trailer bed 12 by bolts or other standard fixing devices. Alternatively, the coupling device 17 may be attached elsewhere on the trailer bed 12. Moreover, coupling device 17 may be designed to be sold separately from the trailer bed 12 or as an integral piece of the trailer bed 12.

FIG. 4 shows two wheel positioners 16 coupled to the coupling device 17. In the preferred embodiments, the wheel positioners 16 are slidable along the coupling device 17 so as to adjust for varying sizes of wheeled vehicles 10. Fixing device 26 is a screw, bolt, or other similar device that allows a person to fix the wheeled positioners 16 at desired positions along the coupling device 17. It should be noted that some embodiments of the present invention contemplate coupling the wheel positioners 16 directly to the trailer bed 12 by a much simpler coupling device 17 comprising bolts or other simple fixing devices.

FIG. 5 shows an adjustable bar 23 (see also FIG. 3A) in accordance with one embodiment of the present invention. This particular adjustable bar 23 has niches 28 that allow the wheel positioners 16 to adjust for varying wheel diameters. An extention (not shown) on the wheel positioners 16, for example, can be inserted into any of the niches 28 to effect this adjustment. Any means of adjusting for varying wheel diameters, however, may be incorporated into the wheel positioners 16 of the present invention. Note that the embodiment in FIG. 3B uses pins 30 to provide adjustability.

In some systems of the present invention, only one wheel positioner 16 is attached to the trailer bed 12. This system might be appropriate for loading motorcycles on a trailer bed, for example. In some systems of the present invention, multiple wheel positioners 16 can be used to, for example, set two wheeled vehicles 10 or ATVs side-by-side on a trailer bed 12. Also, some embodiments may comprise ramps 18 that are not pivotable but that remain stationery. Also, in the preferred embodiments of the present invention, the ramps 18 preferably comprise GRIP STRUT™ (manufactured by GS Metals, Corp. of Illinois) or similar material. However, the ramps 18 can be made of any material strong enough to withstand the weight of the wheeled vehicles 12.

Thus, the present invention comprises an inventive and simple means for securing wheeled vehicles 10 to a surface 12 for transportation. Once a wheeled vehicle 10 is placed in the wheel positioners 12 of the present invention, the wheel positioners 10 help prevent the wheeled vehicle 10 from rolling backwards or from sliding sideways on the trailer bed 12 while being transported.

It is underscored that the present invention may be embodied in other specific forms without departing from its spirit or essential characteristics. The described embodiments herein should be deemed only as illustrative.

What is claimed is:

1. A system comprising:
a ramp;
a seat, coupled to said ramp, for seating a wheel on a wheeled vehicle; and
a coupling device for coupling said ramp and said seat to a transporting surface.

2. The system of claim 1 wherein said ramp is pivotable between a first slanted position and a second slanted position, the first position allowing said wheel to roll upwards along the ramp, the second position preventing the wheel from rolling backwards along the transporting surface.

3. The system of claim 1 wherein said ramp further comprises a biasing device for biasing said ramp.

4. The system of claim 3 wherein the biased ramp is biased so that when said wheel rolls over said ramp, the weight of the wheel causes the ramp to pivot around an axis.

5. The system of claim 1 wherein the ramp automatically flips back to the first position after the wheel is seated in the seat.

6. The system of claim 1 wherein the transporting surface comprises a flatbed trailer.

7. The system of claim 1 wherein said seat further comprises parts shaped to fit a motorcycle wheel.

8. The system of claim 7 wherein said parts comprise a v-shaped cradle and an angled wheel rest.

9. The system of claim 1 wherein said coupling device comprises means for adjusting the coupling device to accommodate a variety of wheeled vehicle widths.

10. The system of claim 1 further including an adjustable bar that allows the system to be adjusted to accommodate various wheel diameters.

11. The system of claim 1 comprising a plurality of ramps and seats.

12. The system of claim 1 wherein said ramp is stationery.

13. The system of claim 1 wherein said ramp and seat work together to prevent said wheel from rolling either backwards or forwards along said transporting surface.

14. The system of claim 13 wherein said ramp and seat are shaped so as to further prevent said wheel from shifting sideways along said transporting surface.

15. The system of claim 13 wherein said ramp automatically flips back to its original position after said wheel rolls over the ramp.

16. A system comprising:
a wheel positioner comprising:
a pivotable ramp;
a seat, coupled to said ramp, for seating a wheel on a wheeled vehicle; and
a coupling device for coupling said wheel positioner to a substantially flat transporting surface.

17. The system of claim 16 comprising means for pivoting said ramp between a first slanted position and a second, oppositely slanted position.

18. The system of claim 17 wherein said seat prevents the wheel from moving forwards and sideways, and the ramp, when in the second position, prevents the wheel from moving backwards along the transporting surface.

19. The system of claim 16 wherein said seat further comprises means for guiding and gripping a motorcycle wheel.

20. A method for transporting a wheeled vehicle on a trailer comprising:
rolling a wheel of a wheeled vehicle over a pivotable ramp and into a seat coupled to the trailer;
transporting said trailer with an automobile; and
pivoting the ramp so as to allow the wheel to roll backwards off of the trailer.
